(19) United States
(12) Patent Application Publication
(10) Pub. No.: US 2007/0222256 A1
(43) Pub. Date: Sep. 27, 2007

(54) Hybrid door core and trim module with integrated components

(76) Inventors: Jeffrey Valentage, Royal Oak, MI (US); Joseph Gustaaf Marie Flendrig, Brussels (BE)

Correspondence Address: ExxonMobile Chemical Company;Law Technology, P.O. Box 2149, Baytown, TX, 77522-2149, US

(21) Appl. No.: 11/704,095

(22) Filed: Feb. 8, 2007

Related U.S. Application Data
(63) Continuation-in-part of application No. 11/590,307, filed on Oct. 31, 2006.
(60) Provisional application No. 60/785,265, filed on Mar. 23, 2006.

(51) Int. Cl. B60J 5/00

(52) U.S. Cl. 296/146.6; 296/146.7; 49/503

(57) ABSTRACT

This invention relates to an integrated door system, comprising:
an outer panel;
a trim panel module having a first and a second side, the first side adapted to communicate with an interior of a vehicle and the second side adapted to attach to the outer panel;
a window surround disposed between the outer panel and the second side of the trim panel module; and
an integrated reinforcement assembly disposed on the second side of the trim panel module and about a lower portion of the window surround.

### CROSS REFERENCE TO RELATED APPLICATIONS

This application claims the benefit of and priority from U.S. Ser. No. 60/785,265, filed Mar. 23, 2006. This application is also a continuation-in-part of Ser. No. 11/590,307, filed Oct. 31, 2006. All of the above applications are fully incorporated herein by reference.

### BACKGROUND OF THE INVENTION

1. Field of the Invention

This invention relates to door systems. More particularly, embodiments of the present invention relate to door systems for vehicles, such as automobiles, specifically cars and trucks

2. Description of the Related Art

Conventional doors for automobiles contain many individual pieces that are assembled to a door frame or shell before the final door product is attached to the vehicle's chassis. Automotive doors can have more than fifty to greater than one hundred individual components depending on the vehicle and option package. Such components can include various hardware, electrical parts, and sealing members. Illustrative hardware components can include window regulators, window tracks, windows, door locks, and impact bolsters. Certain electrical components can include wire harnesses, speakers, window motors, and outside mirror motors. Sealing components can include glass run channels, beltlines, lower sashes, plugs, grommets, and core to frame seals.

Each component is typically supplied by a different vendor or supplier, some of which are known in the industry as Tier 1, Tier 2, and Tier 3 suppliers. In most cases, an original equipment manufacturer (OEM) produces a door frame and exterior skin that are typically stamped separately from cold rolled steel, welded together, and painted to provide a door shell. The numerous individual components from the Tier 1, 2, and 3 suppliers are then assembled onto the OEM's door shell, typically at the OEM's assembly line.

The process of affixing the components to the door shell is time intensive and requires large amounts of costly floor space. Each component is attached to the door shell using at least one of many different means including clips, screws, fittings, adhesives, just to name a few. In most cases, twenty to forty five different assembly steps are needed to complete the entire assembly process of the door.

FIG. 1 shows a schematic illustration of a conventional door 100. Typically, the door 100 has an interior trim panel 110, inner panel 120, intrusion beam 130, reinforcement section 140 and 145A, latch assembly 145B, and outer panel 150. Typically, the inner panel 120, intrusion beam 130, reinforcement section 140, and outer panel 150 are each formed from steel, stamped, welded together, and painted at the OEM. The numerous hardware, electrical and sealing components such as those listed above (not shown in FIG. 1 for simplicity) are typically assembled onto the steel inner panel 120 at the OEM. Similarly, the various components on the interior trim panel 110, including lights, switches, armrests, map pockets, handles, etc., (also not shown for simplicity) are assembled at a Tier supplier and shipped to the OEM. The OEM attaches the assembled trim panel 110 to the assembled inner panel 120, and the final electrical and hardware connections are made.

Accordingly, the door manufacturing process is intensive and time consuming. The assembly process also requires a high degree of logistical planning to ensure all the parts are available and assembled in the correct manner and order. Other incidental and related costs include ordering, storage, management, transportation, functionality testing, quality control, in addition to the floor space to assemble the various components. All those factors add up to a costly end product.

Cost savings and part consolidation ideas have tried using pre-assembled mounting panels with all or part of the hardware and electrical components assembled thereon as shown in FIG. 2. FIG. 2 shows a schematic illustration of a conventional door 200 having a pre-assembled mounting panel 210. Numerous components are assembled to the mounting panel 210, including an interior door handle 215, handle linking cables 220, window motor 225, window regulator 230, speaker 235, window guide rail 240, drum pulley 245, cable 250, and door lock unit 260.

All or part of the hardware and electrical components can be installed onto the mounting panel 210 at an outside supplier, such as a Tier 1 supplier. The mounting panel 210 is typically made from stamped steel, thermoformed glass mat reinforced thermoplastic (GMT), or injection molded long glass fiber reinforced polypropylene. Once the applicable components are assembled onto the mounting panel 210 at the outside supplier, the assembled mounting panel 210 is transported to the OEM for installation on a door panel sub-assembly or outer panel 270. An interior trim panel 280 is then attached to the outer panel 270. Other part consolidation ideas are described in U.S. Pat. Nos. 6,857,688; 6,640,500; 6,546,674; 6,449,907; 5,820,191; 5,355,629; 5,040,335; 4,882,842; 4,648,208; and WO 01/25055 A1.

Several examples of pre-assembled mounting panels are believed to be in production. However, the number of components and the required assembly time of the door is substantially the same. The cost benefits to the OEM are mainly due to logistical cost savings absorbed by the Tier suppliers.

There is a need, therefore, for a door assembly having fewer components. There is also a need for a door assembly that minimizes the number of components requiring assembly.

### SUMMARY OF THE INVENTION

This invention relates to an integrated door system, comprising:

a) an outer panel;
b) a trim panel module having a first and a second side, the first side adapted to communicate with an interior of a vehicle and the second side adapted to attach to the outer panel;
c) a window surround disposed between the outer panel and the second side of the trim panel module; and
d) an integrated reinforcement assembly disposed on the second side of the trim panel module and about a lower portion of the window surround.

### BRIEF DESCRIPTION OF THE DRAWINGS

FIG. 1 is a schematic illustration of a conventional door as used in the prior art.

FIG. 2 is a schematic illustration of a conventional door having a pre-assembled mounting panel as used in the prior art.

FIG. 3 is a schematic view of one illustrative embodiment of an integrated door system according to one or more embodiments described.

FIG. 4 is a schematic illustration of the outer panel shown in FIG. 3.

FIG. 5 is a partial plan view of the window surround shown in FIG. 3.

FIG. 6 is an enlarged, partial cross-section of the window surround 320 along lines A-A of FIG. 5.

FIG. 7 is a schematic illustration of an illustrative reinforcement assembly according to one or more embodiments described.

FIG. 8 is a schematic illustration of another illustrative reinforcement assembly according to one or more embodiments described.

FIG. 9 is a schematic illustration of yet another illustrative reinforcement assembly according to one or more embodiments described.

FIG. 10 is a schematic view of the exterior side of the outer panel according to one or more embodiments described.

FIG. 11A is a schematic view of the exterior side of the trim module according to one or more embodiments described.

FIG. 11B is a schematic view of the interior side of the trim module according to one or more embodiments described.

FIG. 12 is a schematic view of another illustrative trim module according to one or more embodiments described.

FIGS. 13A, 13B, and 13C show an illustrative window lift system that can be used with the integrated system according to one or more embodiments described.

FIGS. 14A, 14B, and 14C show another illustrative window lift system that can be used with the integrated system according to one or more embodiments described.

FIG. 15 is a schematic view of certain sealing systems that can be integrated into the door system according to one or more embodiments described.

FIG. 16 is another schematic view of certain sealing systems that can be integrated into the door system according to one or more embodiments described.

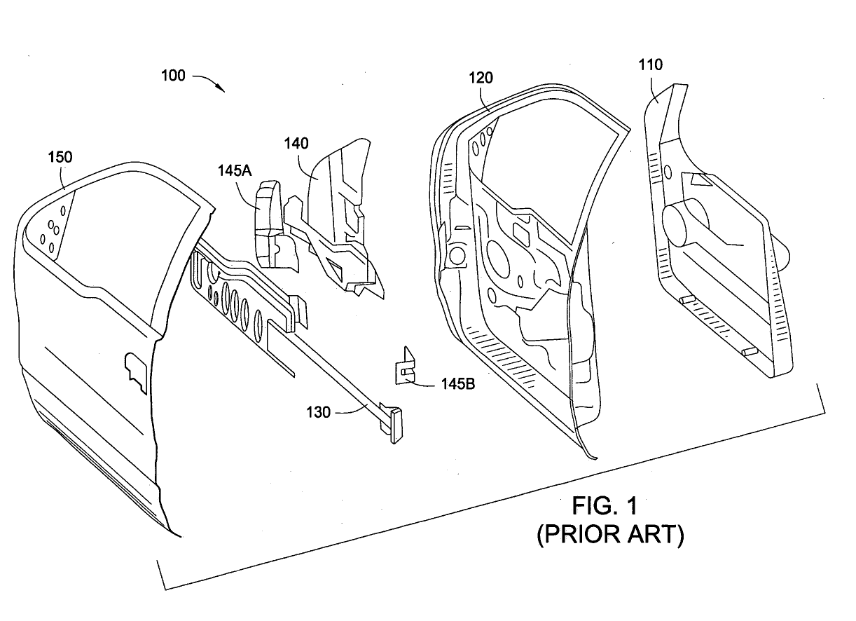

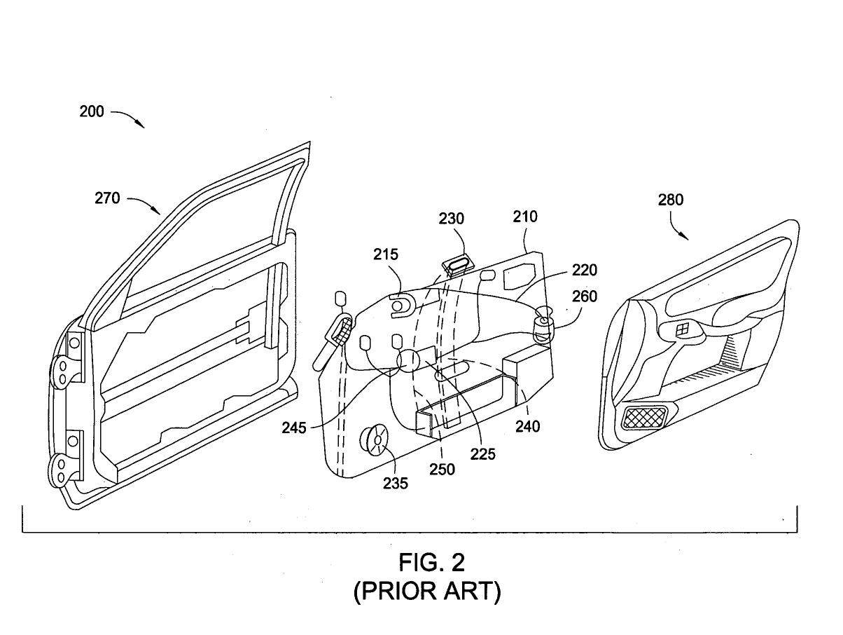

### DETAILED DESCRIPTION OF THE INVENTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information is combined with available information and technology.

A door system that combines a core module and trim panel into one panel or structure is provided. The door system further integrates one or more hardware, electrical components, and sealing systems onto the trim panel module to reduce the number of individual components requiring assembly. Due to its simplicity and high level of integration, the integrated door system reduces the number of individual components (i.e., parts) and assembly steps to produce a finished door. Preferably, the door system utilizes multi-material injection molding technology and/or in-mold assembly techniques to integrate the various components. As such, the number of components requiring assembly is minimized, thereby reducing assembly time, floor space, and associated costs. As used herein the term “door” is intended to include any door. For example, the term “door” can refer to one or more passenger doors, whether hinged, sliding, lifting or with any other alternative opening/closing movement, lift gates, tail gates, and hatchbacks for any vehicle including cars, trucks, SUVs, trains, boats, airplanes, etc., whether for personal, recreational, or commercial use.

FIG. 3 shows a schematic view of an illustrative integrated door system 300 in accordance with one or more embodiments described. In at least one specific embodiment, the door system 300 includes an outer panel 310 having an interior or first side 310A, window surround 320, trim panel module 330, and reinforcement assembly 340. The reinforcement assembly 340 can be a separate system adhesively bonded, screwed, riveted, or otherwise directly installed onto the trim panel module 330. Alternatively, the reinforcement assembly 340 can be a separate system adhesively bonded, screwed, riveted, or otherwise installed onto the outer panel 310.

In one or more embodiments, the reinforcement assembly 340 is integrated with the outer panel 310. For example, the reinforcement assembly 340 can be insert molded into the outer panel 310, thus integrating the outer panel 310 and reinforcement assembly 340 into one component. In one or more embodiments, the reinforcement assembly 340 is integrated with the trim panel module 330 by insert molding the assembly 340 into the trim panel module 330.

Following the assembly or integration of the reinforcement assembly 340, the window surround 320 can be assembled or otherwise attached to the trim panel module 330. The outer panel 310 can then be attached to the trim panel module 330 and window surround 320, completing the assembly of the door system 300. The components 310, 320, 330, and 340 can each be installed/attached using any known method and/or technique. In one or more embodiments, any one or more of the panels 310, 320, and 330 can include one or more integrated connectors or plugs (not shown) injection molded therewith to facilitate connection to one another. A common connector is known as a “Christmas tree” for its conical shape.

Preferably, the door system 300 utilizes multi-material injection molding technology to integrate the various components. In one or more embodiments, each of the outer panel 310, window surround 320, trim panel module 330, and reinforcement assembly 340 can be produced using one or more multi-material or multi-shot injection molding techniques. Multi-material injection molding techniques allow two or more materials to be injection molded into a single or multiple cavity mold. A two component or material process is commonly known as “2K” and a three material process is commonly known as “3K.” Any suitable multi-material injection molding machine can be used, such as an Engel Victory Combi machine available from Engel Corp.

Additional in-mold processing techniques can also be used to enhance and/or facilitate the integration. Illustrative in-mold processing techniques include, but are not limited to, multiple cavity tools, insert molding, movable core sections, and gas/water assist. Robotic extrusion can also be used alone or in combination with any of these processing techniques. Robotic extrusion is particularly useful for applying the sealing members into the injection mold.

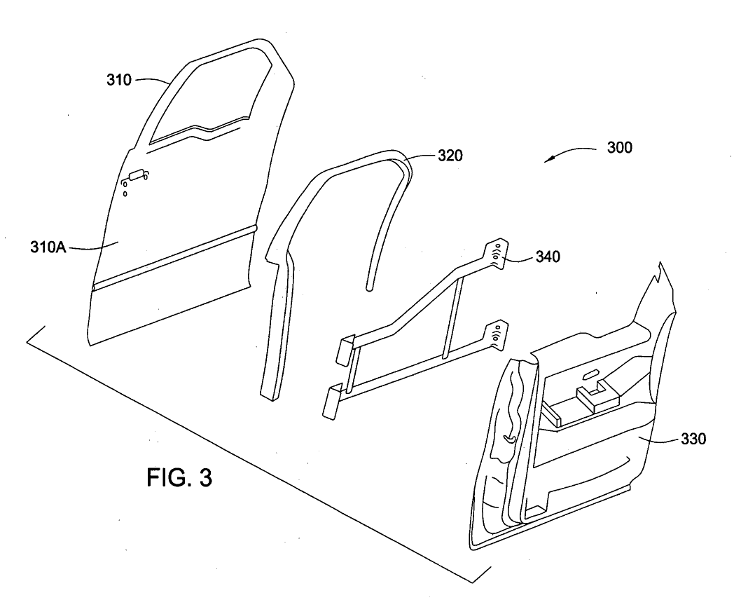

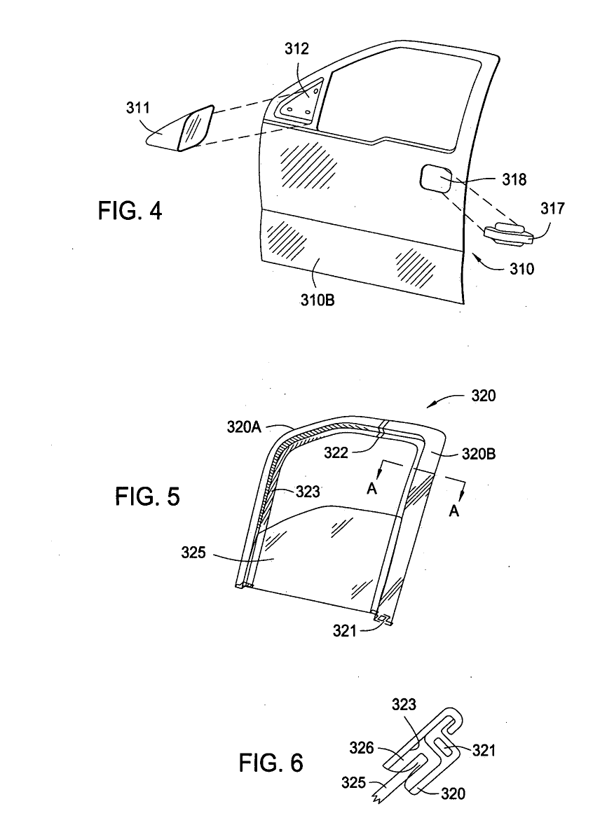

Considering the outer panel 310 in more detail, FIG. 4 shows a schematic plan view of an illustrative outer panel 310. The outer panel 310 has a first or interior side 310A (shown in FIG. 3) and a second or exterior side 310B. A side mirror 311 can be assembled at location 312 on the exterior side 310B of the outer panel 310. A door handle 317 can be assembled at location 318 on the exterior side 310B the outer panel 310. As used herein, the term “interior” refers to an orientation or direction facing toward the passenger compartment or inside of the vehicle, and the term “exterior” refers to an orientation or direction facing away from the passenger compartment or inside of the vehicle.

The outer panel 310 can be stamped from one or more metals and metal alloys, and painted to meet the specifications of the OEM. Suitable metals include steel and aluminum. Alternatively, the outer panel 310 can be injection molded. Any suitable material, including polyethylene, polypropylene, or any one or more materials described herein can be used. Preferably, the outer panel 310 is injection molded from polypropylene or a reinforced polypropylene.

FIG. 5 shows a partial plan view of the window surround 320. The window surround 320 can be made from one or more separate members that that are fitted, adhered, mechanically fastened or otherwise attached together. For example, the window surround 320 can include two separate members 320A, 320B that are connected or adjoined together at joint 322, as shown in FIG. 5. Depending on the material(s) of construction, the separate members 320A, 320B can be butt welded, bonded, or otherwise attached using known methods and techniques.

In one or more embodiments, the window surround 320 can include one or more channels or hollow sections 321 at least partially formed therein. The hollow sections 321 can be formed using water or gas assist techniques. The hollow sections 321 add strength to the window surround 320. The hollow section 321 can be formed continuously throughout the window surround 320. Alternatively, the window surround 320 can include two or more discontinuous hollow sections 321 dispersed throughout. The design (i.e., depth, length and thickness) and location (i.e., spacing) of the hollow sections 321 can vary depending on the desired strength and stiffness requirements. Further, the hollow section 321 can have any shaped cross section. Illustrative cross sections include circular, rectangular, triangular, and hat-shaped, just to name a few.

In one or more embodiments, the window surround 320 can include a recessed channel or glass run channel 323. The recessed channel 323 provides a track or guide for which the window glass 325 can ride as the glass 325 is raised or lowered. A slip coating (not shown in this view) can be disposed on the glass run channel 323 to reduce friction and vibration between the glass 325 and the channel 323. Preferably, the slip coating is added by injection molding or applied using robotic extrusion.

FIG. 6 is an enlarged, cross-section of the window surround 320 and recessed channel 323 along lines A-A of FIG. 5. In one or more embodiments, the window surround 320 can include a seal or slip coating 326 disposed within the recessed channel 323. The seal 326 can be a separate component that is assembled onto the window surround 320. Preferably, the seal 326 can be insert molded into the window surround 320. Alternatively, the seal 326 can be an integral component that is injection molded onto the recessed channel 323 with the remainder of the window surround 320. The seal is preferably second shot injection molded using a multi-material injection molding machine.

Considering the reinforcement assembly 340 as shown in FIG. 3 in more detail, the reinforcement assembly 340 can be made from any material discussed herein. As mentioned, the reinforcement assembly 340 can be a separate system that is adhesively bonded, screwed, riveted, or otherwise attached directly onto the outer panel 110 or the trim panel module 330. Alternatively, the reinforcement assembly 340 can be made as an integrated part of either the outer panel 310 or the trim panel module 330. For example, the reinforcement assembly 340 can be insert molded to the injection mold of the outer panel 310 or the trim panel module 330.

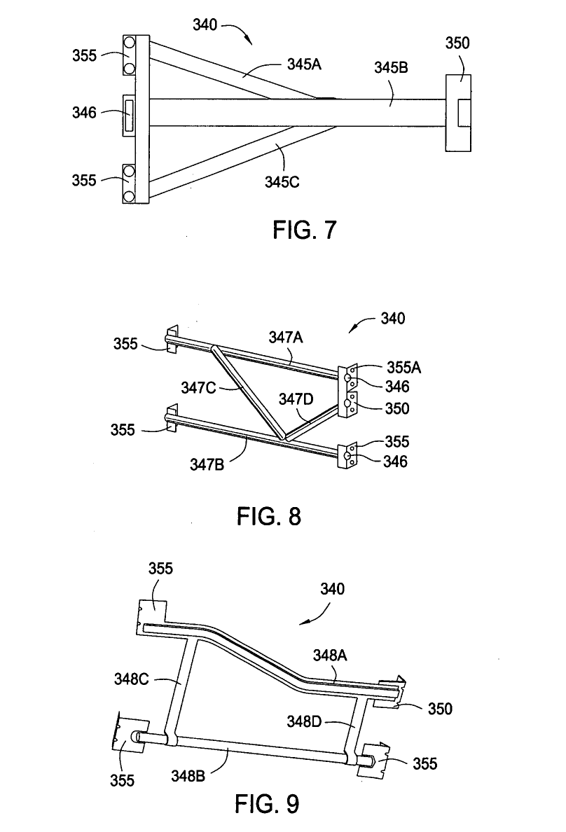

FIG. 7 is a schematic plan view of one embodiment of a reinforcement assembly 340. In this embodiment, the assembly 340 includes one or more reinforcement beams (three are shown 345A, 345B, 345C), latches 350 and hinges 355. The one or more reinforcement beams 345A, 345B, 345C are preferably constructed from steel, aluminum, or any other suitable material. In one or more embodiments, the beam 345B has a hollow cross section to provide a channel 346 for one or more electrical wires or mechanical cables, such as those used for the powered windows, door locks, side mirrors, lights, etc. The cross section of each beam 345A, 345B, 345C can be made in different configurations including circular, rectangular, and hat shaped, depending on the required strength and stiffness. The main consideration is that the requisite stiffness and side intrusion requirements for the particular vehicle segment are met.

The beams 345A, 345C are attached to the beam 345B at a first end thereof and include one or more hinges 355 at a first end thereof. Preferably, the hinges 355 are welded to the beams 345A, 345C. The hinges 355 allow easy installation of the assembly 345 to the outer panel 110 or the trim panel module 330. The door latch 350 is attached to the beam 345B and communicates with the lock system located on the B pillar of the vehicle (not shown).

FIG. 8 shows a schematic illustration of another embodiment of the reinforcement assembly 340 that can be used. In this embodiment, the reinforcement assembly 340 includes a plurality of individual support bars 347A, 347B, 347C, 347D (four are shown) welded together. Side bars 347A and 347B can be arranged in parallel or substantially parallel. A first cross bar 347C is welded at a first end thereof to the first side bar 347A and at a second end thereof to the second side bar 347B. A second cross bar 347D is welded at a first end thereof to a dual hinge member 355A. The dual hinge member 355A is connected to one end of the first side bar 347A. The second cross bar 347D is welded at a second end thereof to the second side bar 347B, adjacent the weld of the first cross bar 347C to the second side bar 347B. This configuration provides additional strength against side intrusion although many other configurations having any number and any combination of cross and side bars are envisioned. Additional hinges 355 can be added to respective ends of the first side bar 347A and/or second side bar 347B as shown.

The cross section of the bars 347A-D can be made in different configurations including circular, rectangular, and hat-shaped, depending on the required strength and stiffness. The main consideration is that the requisite stiffness and side intrusion requirements for the particular vehicle segment are met. In one or more embodiments above or elsewhere herein, any one or more of the side bars 347A, 347B and or cross bars 347C, 347D can be hollow to provide a channel 346 for any electrical wires or mechanical cables, as mentioned. FIG. 8 shows a channel 346 formed in both side bars 347A, 347B although the channels 346 can be formed in any one or any combinations of the bars 347A-D.

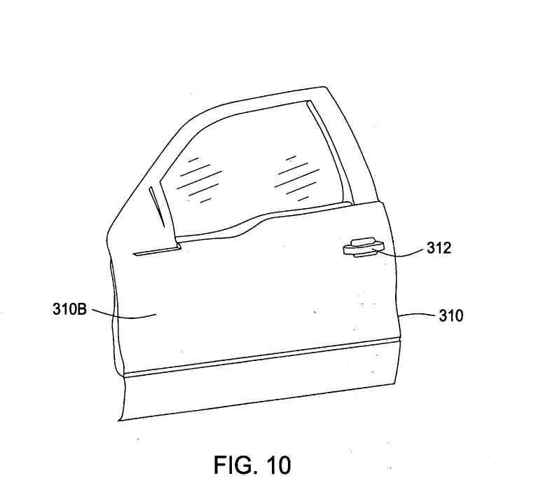

FIG. 9 shows a schematic illustration of yet another embodiment of the reinforcement assembly 340 that can be used. In this embodiment, the reinforcement assembly 340 includes at least one latch 350, one or more hinges 355, one or more side bars (two are shown 348A, 348B), and one or more support bars (two are shown 348C, 348D). The side bars 348A, 348B can be of any length, but the bars are preferably designed to run the width of the door.

The side bars 348A, 348B can be vertically spaced and connected with the vertical bars or support bars 348C, 348D. The support bars 348C, 348D are preferably welded at respective ends or along the lengths of the side bars 348A, 348B. The support bars 348C, 348D are preferably located along the length, more preferably near the ends of the length, of the side bars 348A, 348B, as shown.

The side bars 348A, 348B can be arranged in parallel or substantially parallel. The side bars 348A, 348B can be straight, bent, or curved depending on the style of the door and the components disposed thereon. Preferably, the first side bar 348A is positioned near the upper portion of the door and the second side bar 348B is positioned near the lower portion of the door. Similarly, the support bars 348C, 348D can be straight or curved depending on the style of the door and the components disposed thereon. Preferably, the first support bar 348C is positioned some where in the A pillar half of the door and the second support bar 348D is positioned some where in the B pillar portion of the door.

As in any of the embodiments above, any of the bars 348A-B can be hollow to provide a conduit or channel for electrical wires or mechanical cables. Further, the cross section of the bars 348A-D can be made in different configurations including circular, rectangular, and hat-shaped, depending on the required strength and stiffness. The main consideration is that the requisite stiffness and side intrusion requirements for the particular vehicle segment are met.

FIG. 10 is a schematic view of the exterior side 310B of the outer panel 310. Here, the outer panel 310 is shown having a door handle 312 attached thereon. During assembly, the trim panel module 330 is attached to the interior side (not shown in this view) of the outer panel 310.

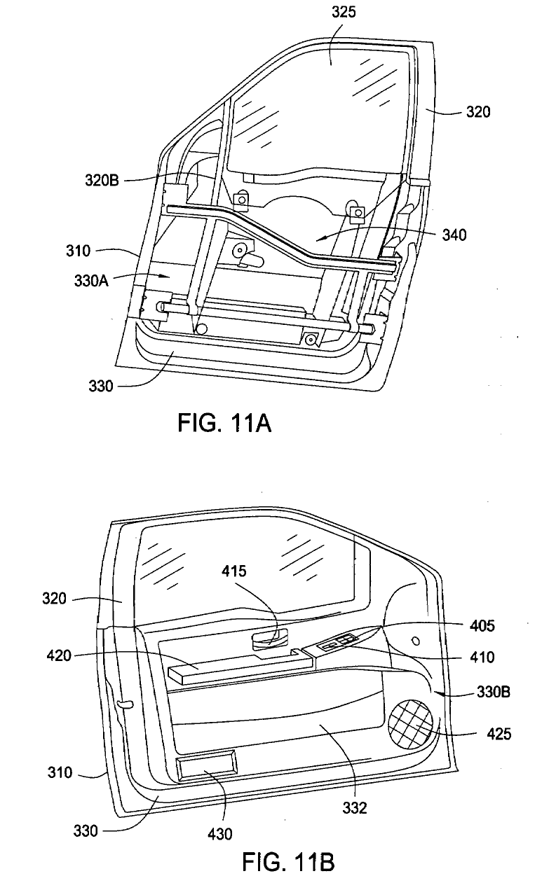

FIG. 11A shows a schematic view of the first (“exterior”) side 330A of an illustrative trim panel module 330. The first side 330A is assembled adjacent the interior side 310A of the outer panel 310, which is better understood with reference to FIG. 3. The trim panel module 330 is shown having the reinforcement assembly 340 assembled thereto. The window surround 320 is also attached to the trim panel module 330. As shown in this view, a portion 320B of the window surround 320 is arranged behind the reinforcement assembly 340 and serves as a glass run channel for the window glass 325 when installed. During assembly, the window glass 325 can be installed into the window surround 320 and then the window surround 320 is attached to the trim panel module 330.

FIG. 11B shows a schematic view of the interior (“second”) side 330B of the trim panel module 330. The trim panel module 330 is shown attached to the outer panel 310 to form the integrated door system 300. For simplicity and ease of description, the interior side 330B of the trim panel module 330 is shown only having one or more window switches 405, door lock switches 410, door handle 415, arm rest 420, speaker cover 425, lights 430, and map pocket 332. It is to be understood, however, that the interior side 330B of the trim panel module 330 can have any feature and option depending on the make and model of the car, including for example, side mirror heater vents, side mirror controls, additional speakers, etc.

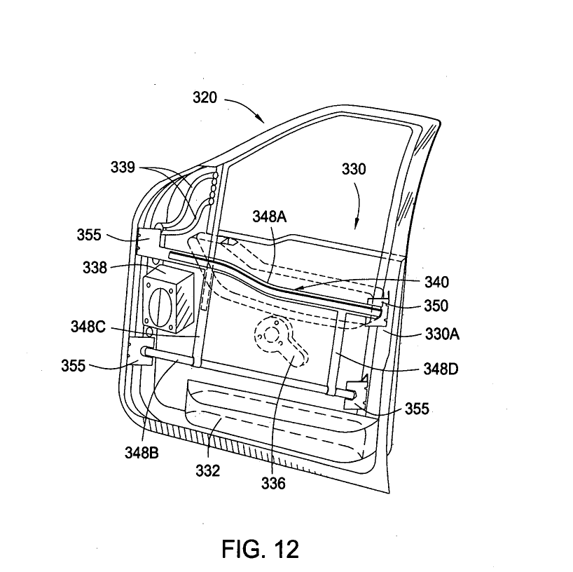

FIG. 12 shows a schematic view of another illustrative trim panel module 330 according to one or more embodiments described. The first (“exterior”) side 330A of the trim panel module 330 is shown. The reinforcement assembly 340 is positioned about the lower portion of the window surround 320 defining a space therebetween for the window glass (not shown) to move. As shown, the trim panel module 330 further includes an integrated map pocket 332, motor support 336, speaker box 338, and air distribution channel 339 for heat or air. Any of such components can be integrally formed with the trim panel module 330 using one or more injection or insert molding techniques described herein. In one or more embodiments above or elsewhere herein, the components are injection molded with a living hinge (not shown). Once the component has been molded, the hinged component is simply folded over and snapped in place. Alternatively, the component can be welded or adhered to the trim panel module 330. Preferably, the map pocket 332 and/or the speaker box 338 are molded with a living hinge.

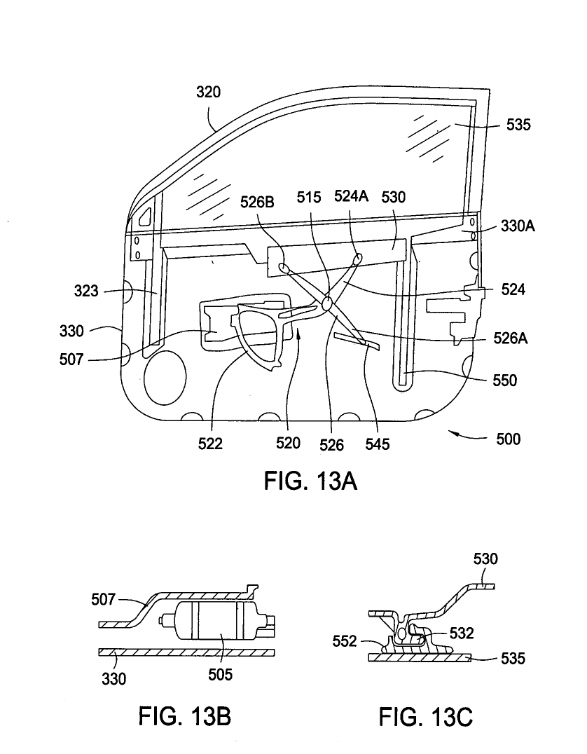

FIGS. 13A-13C show schematic views of the integrated trim panel module 330 and upper window surround 320 having an illustrative window lift systems 500. In at least one embodiment, the window lift system 500 includes a cross arm lifter 520, regulator 530, and window tracks 545, 550. The cross arm lifter 520 includes a gear or toothed member 522, a first extension member 524, and a second extension member 526. The trim panel module 330 can further include an integrated motor housing or receptacle 507 that is injection molded with the trim panel module 330. The housing 507 can be molded on either the first (“interior”) or second (“exterior”) side of the trim panel module 330, depending on design details.

Referring to FIG. 13B, lift motor 505 can be attached to the integrated housing or receptacle 507. The motor 505 can be easily mounted on or assembled to the housing 507 using a snap connection, rivet, screw, or by any other fastener (not shown). Referring again to FIGS. 13A and 13B, the motor 505 drives the toothed member 522 about a pivot point 515 in either a clockwise or counterclockwise direction. The toothed member 522 is attached to or is integral with the first extension member 524. The first extension member 524 has a first end 524A that is attached to the regulator 530. The regulator 530 is attached to the bottom of the window glass 535. At least a portion of the regulator 530 is configured to fit within the integrally formed track 550. The track 550 is integrally formed with the core module 400 via injection molding using one or more of mono material molding, 2-K molding, in-mould labeling, and insert molding techniques, as explained above. The regulator 530 and the window track 550 can each be formed to have mating profiles 532, 552 that when engaged, the regulator 530 is guided along the profile 552 of the track 550 as shown in FIG. 13C.

The first extension member 524 is pivotally connected at pivot point 515 to the second extension member 526. A first end 526A of the second extension member 526 communicates with the track 545. A second end 526B of the second extension member 526 is attached to the regulator 530. The track 545 can be integrally formed with the trim panel module 330 via injection molding or the track 545 can be a separate part, such as a rail like member that is attached to the core module 400. The track 545 can also be insert molded into the trim panel module 330. As the motor 505 drives the toothed member 522, the extension members 524 and 526 work together via the pivot point 515 to raise or lower the regulator 530 and hence, the window glass 535. The window glass 535 is supported by the regulator 530 and the glass run channel 323.

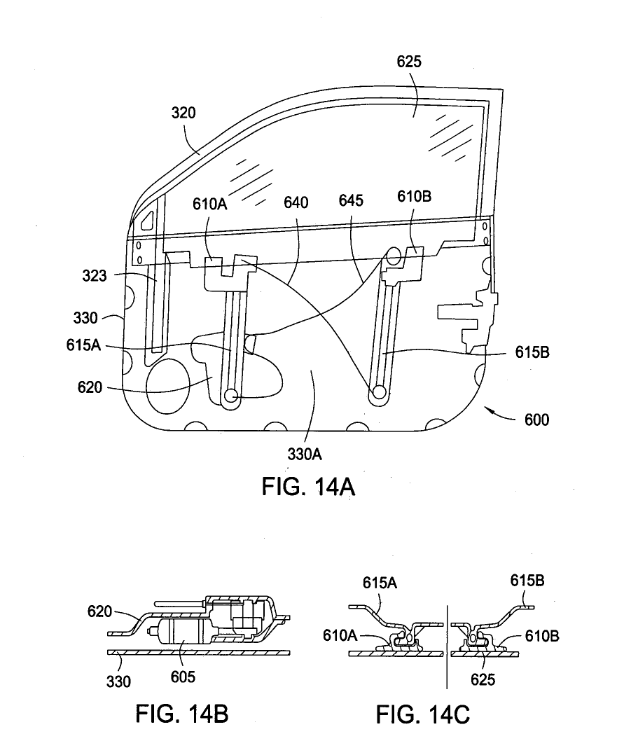

FIGS. 14A, 14B, and 14C show the trim panel module 330 and upper window surround 320 having another illustrative window lift system 600. The window lift system 600 includes a motor housing 620, two or more regulators (610A and 610B), and two or more track members 615A, 615B. The window lift system 600 further includes cables 640 and 645 in communication with the regulators 610A, 610B.

Referring to FIGS. 14A and 14B, the motor housing 620 is preferably injection molded with the trim panel module 330. The housing 620 can be molded on either the first (“exterior”) side 330A of the trim panel module 330 or the second (“interior”) side (not shown in this view), depending on design details. A motor 605 can be attached to the integrated motor housing or receptacle 620, as shown in FIG. 14B. The motor 605 can be easily mounted on or assembled to the motor housing 620 using a snap connection, rivet, screw, or by any other fastener (not shown).

Referring to FIG. 14C, the window 625 is secured to the regulators 610A, 610B by one or more fasteners and/or adhesive type material (not shown). The regulators 610A, 610B are each configured on a track member 615A, 615B. The regulators 610A, 610B and the window tracks 615A, 615B can each be formed to have mating profiles that when engaged, the regulator 610A or 610B is guided along the profile of its respective track 615A, 615B, as shown in FIGS. 14A and 14C.

Referring again to FIG. 13A, the cables 640 and 645 are tied to the regulators 610A, 610B. The regulators 610A, 610B move the window 625 up or down when the motor 620 alternately draws the cables 640 and 645. The window 625 is supported by the regulators 610A, 610B in communication with the integrally formed tracks 615A and 615B.

Referring to FIGS. 13A and 14A a belt line glass seal or sweep 636, 737 can be integrally molded to the trim panel module 330. The belt line glass seals 636, 737 provide an additional weather seal to prevent water seepage into the door. A water management sheet (not shown), preferably formed of plastic such as polyethylene, polyurethane or a closed cell foam, can be attached to the interior side of the trim panel module 330 to prevent water, noise and/or dust from entering the interior of the door into the passenger compartment.

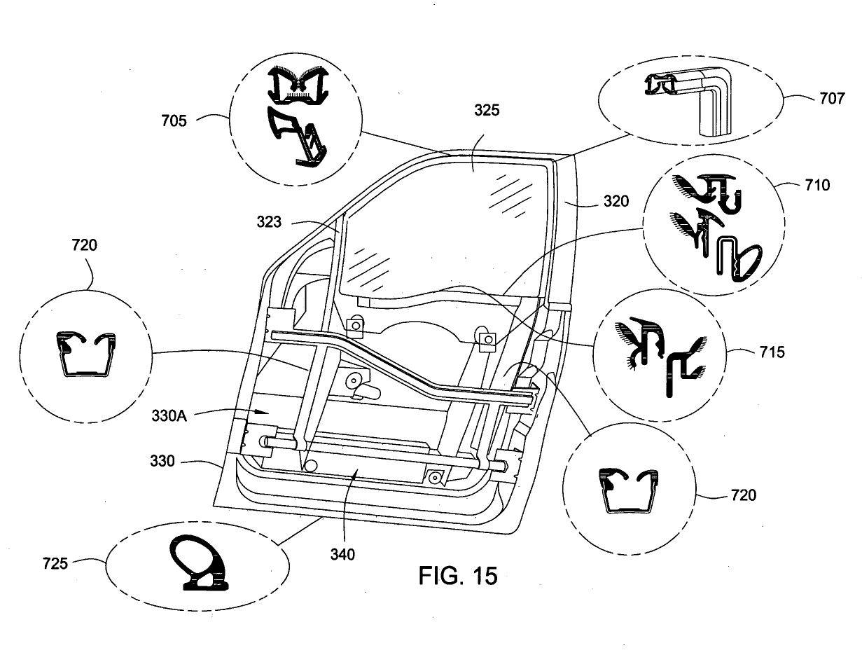

FIG. 15 shows a simplified schematic view of an exterior side 330A of the trim panel module 330 and window surround 320 having one or more sealing systems disposed thereon. As shown, the trim panel module 330 includes a plurality of seals having various profiles for its intended purpose. For example, the window surround 320 can include one or more sealing members having profiles 705, 707 to engage the window glass 325. Preferably, the one or more sealing members having profiles 705, 707 are disposed within the upper portion (e.g., the portion above the belt line) of the glass run channel 323 formed in the window surround 320. One or more sealing members having a profile 710 can be disposed on the outer belt line of the trim panel module 330. One or more sealing members having a profile 715 can be disposed on the inner belt line of the window surround 320. One or more sealing members having a profile 720 can be disposed on a lower portion (e.g., the portion below the belt line) of the glass run channel 323. One or more sealing members having a profile 725 can be disposed on the edge of the trim panel module 330 and serve as the door to frame seal. As mentioned, each one of these sealing members 705, 707, 710, 715, 720, and 725 can be integrally formed via injection molding or insert molding with the body (e.g., window surround 320 and trim panel module 330 disposed thereon).

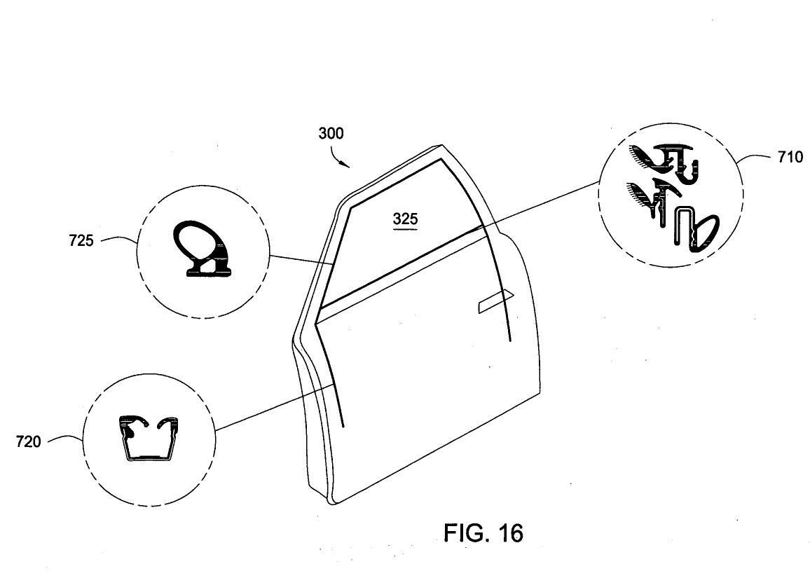

FIG. 16 shows another schematic view of one or more sealing systems disposed about the door. A simplified, exterior plan view of an assembled door system 300 is shown. The door system 300 can include a plurality of seals 710, 720, 725 having various profiles disposed thereon. For example, the perimeter about the window glass 325 can include one or more sealing members having the profiles 720 and/or 725. Preferably, the one or more sealing members having the profile 725 is disposed above the belt line, and one or more sealing members having the profile 720 are disposed below the beltline. One or more sealing members having the profile 710 can be disposed on the inner belt line as shown.

### Materials

The components described, including the trim panel module 330, reinforcement assembly 340, window surround 320, and outer panel 310, can be made from any material having the requisite properties, such as stiffness and strength for example. Suitable materials include, but are not limited to, propylene homopolymers, propylene copolymers, ethylene homopolymers, ethylene copolymers, and or any one or more of the following polymer resins:
a) polyamide resins such as nylon 6 (N6), nylon 66 (N66), nylon 46 (N46), nylon 11 (N11), nylon 12 (N12), nylon 610 (N610), nylon 612 (N612), nylon 6/66 copolymer (N6/66), nylon 6/66/610 (N6/66/610), nylon MXD6 (MXD6), nylon 6T (N6T), nylon 6/6T copolymer, nylon 66/PP copolymer, nylon 66/PPS copolymer;
b) polyester resins such as polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer and other aromatic polyesters;
c) polynitrile resins such as polyacrylonitrile (PAN), polymethacrylonitrile, acrylonitrile-styrene copolymers (AS), methacrylonitrile-styrene copolymers, methacrylonitrile-styrene-butadiene copolymers; and acrylonitrile-butadiene-styrene (ABS);
d) polymethacrylate resins such as polymethyl methacrylate and polyethylacrylate;
e) cellulose resins such as cellulose acetate and cellulose acetate butyrate;
f) fluorine resins such as polyvinylidene fluoride (PVDF), polyvinyl fluoride (PVF), polychlorofluoroethylene (PCTFE), and tetrafluoroethylene/ethylene copolymer (ETFE);
g) polyimide resins such as aromatic polyimides;
h) polysulfones;
i) polyacetals;
j) polyactones;
k) polyphenylene oxides and polyphenylene sulfides;
l) styrene-maleic anhydrides;
m) aromatic polyketones,
n) polycarbonates (PC);
o) elastomers such as ethylene-propylene rubber (EPR), ethylene propylenediene monomer rubber (EPDM), styrenic block copolymers (SBC), polyisobutylene (PIB), butyl rubber, neoprene rubber, halobutyl rubber and the like); and
p) mixtures of any and all of a) through o) inclusive.

In one or more embodiments above or elsewhere herein, the material can include one or more fillers for added strength. Fillers can be present in an amount of from 0.001 wt % to 50 wt % in one embodiment based upon the weight of the composition and from 0.01 wt % to 25 wt % in another embodiment, and from 0.2 wt % to 10 wt % in yet another embodiment. Desirable fillers include but are not limited to titanium dioxide, silicon carbide, silica (and other oxides of silica, precipitated or not), antimony oxide, lead carbonate, zinc white, lithopone, zircon, corundum, spinel, apatite, Barytes powder, barium sulfate, magnesiter, carbon black, dolomite, calcium carbonate, sand, glass beads, mineral aggregates, talc, and hydrotalcite compounds of the ions Mg, Ca, or Zn with Al, Cr, or Fe and CO₃ and/or HPO₄, hydrated or not; quartz powder, hydrochloric magnesium carbonate, short glass fiber, long glass fiber, glass fibers, polyethylene terephthalate fibers, wollastonite, mica, carbon fiber, nanoclays, nanocomposites, magnesium hydroxide sulfate trihydrate, clays, alumina, and other metal oxides and carbonates, metal hydroxides, chrome, phosphorous and brominated flame retardants, antimony trioxide, silicone, and any combination and blends thereof. Other illustrative fillers can include one or more polypropylene fibers, polyamide fibers, para-aramide fibers (e.g., Kevlar or Twaron), meta-aramide fibers (e.g., Nomex), polyethylene fibers (e.g., Dyneema), and combinations thereof.

The material can also include a nanocomposite, which is a blend of polymer with one or more organo-clays. Illustrative organo-clays can include one or more of ammonium, primary alkylammonium, secondary alkylammonium, tertiary alkylammonium, quaternary alkylammonium, phosphonium derivatives of aliphatic, aromatic or arylaliphatic amines, phosphines or sulfides or sulfonium derivatives of aliphatic, aromatic or arylaliphatic amines, phosphines or sulfides. Further, the organo-clay can be selected from one or more of montmorillonite, sodium montmorillonite, calcium montmorillonite, magnesium montmorillonite, nontronite, beidellite, volkonskoite, laponite, hectorite, saponite, sauconite, magadite, kenyaite, sobockite, svindordite, stevensite, vermiculite, halloysite, aluminate oxides, hydrotalcite, illite, rectorite, tarosovite, ledikite and/or florine mica.

When present, the organo-clay is preferably included in the nanocomposite at from 0.1 to 50 wt %, based on the total weight of the nanocomposite. The stabilization functionality may be selected from one or more of phenols, ketones, hindered amines, substituted phenols, substituted ketones, substituted hindered amines, and combinations thereof. The nanocomposite can further comprise at least one elastomeric ethylene-propylene copolymer, typically present in the nanocomposite at from 1 to 70 wt %, based on the total weight of the nanocomposite.

For areas, sections, or components of the door system 300 that need to provide structure, a reinforced polypropylene (PP) is preferred. Most preferred is a PP reinforced with a PET fiber or any other material that is light weight and provides a good balance of stiffness, impact strength, and has a low coefficient of linear thermal expansion (CLTE).

In one or more embodiments above or elsewhere herein, the polymer can be impact modified to provide improved impact resistance. Impact modifiers include, but are not limited to plastomers, ethylene propylene rubber (EPR), ethylene-propylene diene monomer rubber (EPDM), and may be used in combination with compatibilizers like, but not limited to maleated polypropylene, maleated polyethylene and other maleated polymers, hydroxilated polypropylene and other hydroxilated polymers, derivatives thereof, and any combination thereof.

In another embodiment, the material can contain a plastomer, preferably a propylene plastomer blend. The term “plastomer” as used herein refers to one or more polyolefin polymers and/or copolymers having a density of from 0.85 g/cm³ to 0.915 g/cm³ according to ASTM D-4703 Method B or ASTM D-1505, and a melt index (MI) between 0.10 dg/min and 30 dg/min according to ASTM D-1238 at 190° C., 2.1 kg). Preferred plastomers have a melt index (MI) of between 0.10 dg/min and 20 dg/min in one embodiment, and from 0.2 dg/min to 10 dg/min in another embodiment, and from 0.3 dg/min to 8 dg/min in yet another embodiment as measured by ASTM D-1238. Preferred plastomers can have an average molecular weight of from 10,000 to 800,000 in one embodiment, and from 20,000 to 700,000 in another embodiment. The molecular weight distribution (Mw/Mn) of desirable plastomers ranges from 1.5 to 5 in one embodiment, and from 2.0 to 4 in another embodiment. The 1% secant flexural modulus (ASTM D-790) of preferred plastomers range from 10 MPa to 150 MPa in one embodiment, and from 20 MPa to 100 MPa in another embodiment. Further, a preferred plastomer has a melting temperature (Tm) of from 30° C. to 80° C. (first melt peak) and from 50° C. to 125° C. (second melt peak) in one embodiment, and from 40° C. to 70° C. (first melt peak) and from 50° C. to 100° C. (second melt peak) in another embodiment.

In one or more embodiments above or elsewhere herein, the plastomer can be a copolymer of ethylene derived units and at least one of a C3 to C10 α-olefin derived units. Preferably, the copolymer has a density less than 0.915 g/cm³. The amount of comonomer (C3 to C10 α-olefin derived units) present in the plastomer ranges from 2 wt % to 35 wt % in one embodiment, and from 5 wt % to 30 wt % in another embodiment, and from 15 wt % to 25 wt % in yet another embodiment, and from 20 wt % to 30 wt % in yet another embodiment.

In one or more embodiments above or elsewhere herein, the plastomer can be one or more metallocene catalyzed copolymers of ethylene derived units and higher α-olefin derived units, such as propylene, 1-butene, 1-hexene and 1-octene. Preferably, the plastomer contains enough of one or more of those comonomer units to yield a density between 0.860 g/cm³ and 0.900 g/cm³. Examples of commercially available plastomers include: EXACT 4150, a copolymer of ethylene and 1-hexene, the 1-hexene derived units making up from 18 wt % to 22 wt % of the plastomer and having a density of 0.895 g/cm³ and MI of 3.5 dg/min (available from ExxonMobil Chemical Company); and EXACT 8201, a copolymer of ethylene and 1-octene, the 1-octene derived units making up from 26 wt % to 30 wt % of the plastomer, and having a density of 0.882 g/cm³ and MI of 1.0 dg/min (available from ExxonMobil Chemical Company).

Preferred blends for use as the molded material herein typically include of from about 15%, 20% or 25% to about 80%, 90% or 100% polymer by weight; optionally of from about 0%, 5%, or 10% to about 35%, 40%, or 50% filler by weight, and optionally of from about 0%, 5%, or 10% to about 35%, 40%, or 50% plastomer by weight. In one or more embodiments, a preferred blend contains one or more polymers described in an amount ranging from a low of about 15%, 20% or 25% to a high of about 80%, 90% or 100% polymer by weight. In one or more embodiments, a preferred blend contains at least about 1%, 5%, 10%, 15%, or 20% plastomer by weight. In one or more embodiments, a preferred blend contains at least about 1%, 5%, 10%, 15%, or 20% filler by weight.

Preferably, blends for use herein will have a tensile strength of at least 6,500 MPa, at least 7,500 MPa, or at least 9,000 MPa. Further, preferred blends will have a flexural modulus of 1,750 MPa or more, such as about 1,800 MPa or more, or more than about 2,000 MPa.

In addition to the materials and polymers described above, one or more thermoplastic vulcanizates (TPV), thermoplastic elastomer (TPE), thermoplastic olefin (TPO), polyurethanes (PU), or elastomers such as EPR or EPDM can be used for areas or components that need to have sealing properties. Those material can be used in dense (non-foamed) or in foamed state. Most preferably, a TPV is selected due to the inherent mechanical properties that provide excellent sealing capability and the ability to be injection molded. The other aspect of materials will be the compatibalization of the structural and sealing materials, or the ability to adhere to each other. The materials of either the structural and/or sealing systems can be functionalized or have a secondary additive or component added to the material to provided good bondability.

### Assembly Sequence

Referring again to FIG. 3, the door system 300 can be easily assembled. All electrical connections and attachment points to the outer panel 310 can be made in one easy step. For example, the trim panel module 330 is designed so that all electrical and mechanical connections are made when the trim panel module 330 is assembled to the reinforcement assembly 340. Furthermore, the same type of connector design will allow the electrical/mechanical systems of the door system 300 to be connected to the rest of the vehicle (not shown).

In at least one specific embodiment, the integrated door system 300 can be assembled according to the following sequence. First, the wiring harness (connections included), window motor, and speaker are inserted into an injection mold for the trim panel module 330. The trim panel module 330 and the integrated window tracks are then injection molded. A second material, such as TPV, is injection molded on the trim panel module 330 to create the soft components (seals, plugs, grommets). Gas or water assist can be used to create any hollow profiles needed for the structure and/or seals. A third material, such as foam made from polypropylene, polyethylene, polyurethane, thermoplastic vulcanizates or blends thereof, for example, can be injection molded with the trim panel module 330 to create side impact crash pads or bolsters. The completed trim panel module 330 is ejected from the tool. The reinforcement assembly 340 and the window surround 320 are attached to the trim panel module 330 along with any final connections (e.g., mechanical or electrical). The trim panel module 330 is then attached to the outer panel 310. The door system 300 is then ready to be assembled to the vehicle.

As noted above, the degree of integration described will dramatically reduce the cost and complexity of the finished door. The injection molding techniques described can reduce typical assembly errors in addition to the overall cost. The multi-material injection molding techniques described can also provide a unique combination of materials. Further, the number of secondary attachment techniques needed for multiple components such as rivets, screws, adhesives, clips, snaps, etc., is greatly reduced, if not eliminated all together in some instances.

One of ordinary skill in the art will recognize that the door system described can be utilized as a complete system, or the individual components thereof can be utilized separately as individual mini-systems or modular type units to help consolidate two or more components if desired.

This invention also relates to:

1. An integrated door system, comprising:

an outer panel;

a trim panel module having a first and a second side, the first side adapted to communicate with an interior of a vehicle and the second side adapted to attach to the outer panel;

a window surround disposed between the outer panel and the second side of the trim panel module; and

an integrated reinforcement assembly disposed on the second side of the trim panel module and about a lower portion of the window surround.

### 2. The door system of paragraph 1, wherein the trim panel module comprises one or more door lock controls, window controls, and side mirror controls disposed on the first side thereof.

### 3. The door system of paragraph 1 or 2, wherein the lower portion of the window surround comprises one or more profiles for guiding a window glass thereon.

### 4. The door system of paragraph 1, 2, or 3, wherein the window surround includes a low friction coating at least partially injection molded thereon.

### 5. The door system of any of paragraphs 1 to 4, wherein the reinforcement assembly is a separate component assembled onto the second side of the trim panel module.

### 6. The door system of any of paragraphs 1 to 5, wherein the reinforcement assembly is integrated with the trim panel module by being insert molded on the second side of the trim panel module.

### 7. The door system of any of paragraphs 1 to 6, wherein the reinforcement assembly is disposed about the one or more window tracks defining a space for a window glass to move therebetween.

### 8. The door system of any of paragraphs 1 to 7, wherein the reinforcement assembly comprises at least two side bars vertically spaced apart with at least two support bars.

### 9. The door system of paragraph 8, wherein the at least two side bars each include a hinge member disposed at one end thereof.

### 10. The door system of paragraph 8, wherein at least one of the two side bars includes a latch assembly disposed at one end thereof.

### 11. The door system of any of paragraphs 1 to 10, wherein the trim panel module is injection molded with at least one of a speaker box, map pocket, air channel, motor support, and arm rest.

### 12. The door system of any of paragraphs 1 to 11, wherein the window support is injection molded.

### 13. The door system of any of paragraphs 1 to 12, wherein the trim panel module is injection molded with polypropylene.

### 14. The door system of any of paragraphs 1 to 13, wherein the trim panel module is injection molded with reinforced polypropylene.

### 15. The door system of any of paragraphs 1 to 14, wherein the window surround is injection molded with polypropylene.

### 16. The door system of any of paragraphs 1 to 15, wherein the window surround is injection molded with reinforced polypropylene.

17. An integrated door system, comprising:

an outer panel;

a trim panel module having a first and a second side, the first side adapted to communicate with an interior of a vehicle and the second side adapted to attached to the outer panel; and

an integrated reinforcement assembly disposed between the trim panel module and the outer panel.

### 18. The door system of paragraph 17, wherein the trim panel module is directly coupled to the outer panel.

### 19. The door system of paragraph 17 and 18, wherein the trim panel module comprises one or more door lock controls, window controls, and side mirror controls disposed on the first side thereof.

### 20. The door system of any of paragraphs 17 to 19, wherein the reinforcement assembly is a separate component assembled onto the second side of the trim panel module.

### 21. The door system of any of paragraphs 17 to 20, wherein the reinforcement assembly is integrated with the trim panel module by being insert molded on the second side of the trim panel module.

### 22. The door system of any of paragraphs 17 to 21, wherein the reinforcement assembly comprises at least two side bars vertically spaced apart with at least two support bars.

### 23. The door system of paragraph 22, wherein the at least two side bars each include a hinge member disposed at one end thereof.

### 24. The door system of paragraph 22, wherein at least one of the two side bars includes a latch assembly disposed at one end thereof.

### 25. The door system of any of paragraphs 17 to 24, wherein the trim panel module is injection molded with at least one of a speaker box, map pocket, air channel, motor support, and arm rest.

### 26. The door system of any of paragraphs 17 to 25, wherein the trim panel module is injection molded with one or more components having a living hinge attached thereto.

### 27. The door system of any of paragraphs 17 to 26, wherein the trim panel module is injection molded with polypropylene.

### 28. The door system of any of paragraphs 17 to 27, wherein the trim panel module is injection molded with reinforced polypropylene.

### 29. The door system of any of paragraphs 17 to 28, wherein the trim panel module comprises one or more integrated sealing systems injected molded therewith.

### 30. The door system of any of paragraphs 17 to 29, wherein the trim panel module further comprises one or more integrated side bolsters injected molded therewith.

### 31. The door system of any of paragraphs 17 to 30, wherein the reinforcement assembly is assembled on the outer panel.

32. A method for assembling an integrated door system, comprising:

providing an outer panel;

providing a trim panel module having a first and a second side, the first side adapted to communicate with an interior of a vehicle and the second side adapted to attached to the outer panel; and

assembling an integrated reinforcement assembly between the trim panel module and the outer panel.

### 33. The method of paragraph 32, wherein the outer panel is stamped from steel.

### 34. The method of paragraph 32 or 33, wherein the outer panel is injection molded from one or more materials comprising polypropylene, one or more engineering resins, or a combination thereof.

### 35. The method of paragraph 32, 33, or 34, wherein the trim panel module is injection molded.

### 36. The method of any of paragraphs 32 to 35, wherein the trim panel module is injection molded with polypropylene.

### 37. The method of any of paragraphs 32 to 36, wherein the trim panel module is injection molded with reinforced polypropylene.

### 38. The method of any of paragraphs 32 to 37, wherein the trim panel module is directly coupled to the outer panel.

### 39. The method of any of paragraphs 32 to 38, wherein the trim panel module comprises one or more door lock controls, window controls, and side mirror controls disposed on the first side thereof.

### 40. The method of any of paragraphs 32 to 39, wherein the reinforcement assembly is a separate component assembled onto the second side of the trim panel module.

### 41. The method of any of paragraphs 32 to 40, wherein the reinforcement assembly is integrated with the trim panel module by being insert molded on the second side of the trim panel module.

### 42. The method of any of paragraphs 32 to 41, wherein the reinforcement assembly comprises at least two side bars vertically spaced apart with at least two support bars.

### 43. The method of paragraph 42, wherein the at least two side bars each include a hinge member disposed at one end thereof.

### 44. The method of paragraph 42, wherein at least one of the two side bars includes a latch assembly disposed at one end thereof.

### 45. The method of any of paragraphs 32 to 44, wherein the trim panel module is injection molded with at least one of a speaker box, map pocket, air channel, motor support, and arm rest.

### 46. The method of any of paragraphs 32 to 45, wherein the trim panel module is injection molded with one or more components having a living hinge attached thereto.

### 47. The method of any of paragraphs 32 to 46, wherein the trim panel module comprises one or more integrated sealing systems injected molded therewith.

### 48. The method of any of paragraphs 32 to 47, wherein the trim panel module further comprises one or more integrated side bolsters injected molded therewith.

### 49. The method of any of paragraphs 32 to 48, wherein the reinforcement assembly is assembled on the outer panel.

### 50. The method of any of paragraphs 32 to 49, further comprising assembling a window surround between the outer panel and the trim panel module.

### 51. The method of paragraph 50, wherein the reinforcement section is assembled about a lower portion of the window surround.

### 52. The method of paragraph 51, wherein the reinforcement section is assembled about a lower portion of the window surround defining a space for a window glass to pass therethrough.

### 53. The method of paragraph 52, wherein the lower portion of the window surround comprises one or more profiles for guiding a window glass thereon.

### 54. The method of paragraph 51, wherein the window surround includes a low friction coating at least partially injection molded thereon.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents, including priority documents, cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. An integrated door system, comprising:
an outer panel;
a trim panel module having a first and a second side, the first side adapted to communicate with an interior of a vehicle and the second side adapted to attached to the outer panel;
a window surround disposed between the outer panel and the second side of the trim panel module; and
an integrated reinforcement assembly disposed on the second side of the trim panel module and about a lower portion of the window surround.

2. The door system of claim 1, wherein the trim panel module comprises one or more door lock controls, window controls, and side mirror controls disposed on the first side thereof.

3. The door system of claim 1, wherein the lower portion of the window surround comprises one or more profiles for guiding a window glass thereon.

4. The door system of claim 1, wherein the window surround includes a low friction coating at least partially injection molded thereon.

5. The door system of claim 1, wherein the reinforcement assembly is a separate component assembled onto the second side of the trim panel module.

6. The door system of claim 1, wherein the reinforcement assembly is integrated with the trim panel module by being insert molded on the second side of the trim panel module.

7. The door system of claim 1, wherein the reinforcement assembly is disposed about the one or more window tracks defining a space for a window glass to move therebetween.

8. The door system of claim 1, wherein the reinforcement assembly comprises at least two side bars vertically spaced apart with at least two support bars.

9. The door system of claim 8, wherein the at least two side bars each include a hinge member disposed at one end thereof.

10. The door system of claim 8, wherein at least one of the two side bars includes a latch assembly disposed at one end thereof.

11. The door system of claim 1, wherein the trim panel module is injection molded with at least one of a speaker box, map pocket, air channel, motor support, and arm rest.

12. The door system of claim 1, wherein the window support is injection molded.

13. The door system of claim 1, wherein the trim panel module is injection molded with polypropylene.

14. The door system of claim 1, wherein the trim panel module is injection molded with reinforced polypropylene.

15. The door system of claim 1, wherein the window surround is injection molded with polypropylene.

16. The door system of claim 1, wherein the window surround is injection molded with reinforced polypropylene.

17. An integrated door system, comprising:
an outer panel;
a trim panel module having a first and a second side, the first side adapted to communicate with an interior of a vehicle and the second side adapted to attached to the outer panel; and
an integrated reinforcement assembly disposed between the trim panel module and the outer panel.

18. The door system of claim 17, wherein the trim panel module is directly coupled to the outer panel.

19. The door system of claim 17, wherein the trim panel module comprises one or more door lock controls, window controls, and side mirror controls disposed on the first side thereof.

20. The door system of claim 17, wherein the reinforcement assembly is a separate component assembled onto the second side of the trim panel module.

21. The door system of claim 17, wherein the reinforcement assembly is integrated with the trim panel module by being insert molded on the second side of the trim panel module.

22. The door system of claim 17, wherein the reinforcement assembly comprises at least two side bars vertically spaced apart with at least two support bars.

23. The door system of claim 22, wherein the at least two side bars each include a hinge member disposed at one end thereof.

24. The door system of claim 22, wherein at least one of the two side bars includes a latch assembly disposed at one end thereof.

25. The door system of claim 17, wherein the trim panel module is injection molded with at least one of a speaker box, map pocket, air channel, motor support, and arm rest.

26. The door system of claim 17, wherein the trim panel module is injection molded with one or more components having a living hinge attached thereto.

27. The door system of claim 17, wherein the trim panel module is injection molded with polypropylene.

28. The door system of claim 17, wherein the trim panel module is injection molded with reinforced polypropylene.

29. The door system of claim 17, wherein the trim panel module comprises one or more integrated sealing systems injected molded therewith.

30. The door system of claim 17, wherein the trim panel module further comprises one or more integrated side bolsters injected molded therewith.

31. The door system of claim 17, wherein the reinforcement assembly is assembled on the outer panel.

32. A method for assembling an integrated door system, comprising:
providing an outer panel;
providing a trim panel module having a first and a second side, the first side adapted to communicate with an interior of a vehicle and the second side adapted to attached to the outer panel; and
assembling an integrated reinforcement assembly between the trim panel module and the outer panel.

33. The method of claim 32, wherein the outer panel is stamped from steel.

34. The method of claim 32, wherein the outer panel is injection molded from one or more materials comprising polypropylene, one or more engineering resins, or a combination thereof.

35. The method of claim 32, wherein the trim panel module is injection molded.

36. The method of claim 32, wherein the trim panel module is injection molded with polypropylene.

37. The method of claim 32, wherein the trim panel module is injection molded with reinforced polypropylene.

38. The method of claim 32, wherein the trim panel module is directly coupled to the outer panel.

39. The method of claim 32, wherein the trim panel module comprises one or more door lock controls, window controls, and side mirror controls disposed on the first side thereof.

40. The method of claim 32, wherein the reinforcement assembly is a separate component assembled onto the second side of the trim panel module.

41. The method of claim 32, wherein the reinforcement assembly is integrated with the trim panel module by being insert molded on the second side of the trim panel module.

42. The method of claim 32, wherein the reinforcement assembly comprises at least two side bars vertically spaced apart with at least two support bars.

43. The method of claim 42, wherein the at least two side bars each include a hinge member disposed at one end thereof.

44. The method of claim 42, wherein at least one of the two side bars includes a latch assembly disposed at one end thereof.

45. The method of claim 32, wherein the trim panel module is injection molded with at least one of a speaker box, map pocket, air channel, motor support, and arm rest.

46. The method of claim 32, wherein the trim panel module is injection molded with one or more components having a living hinge attached thereto.

47. The method of claim 32, wherein the trim panel module comprises one or more integrated sealing systems injected molded therewith.

48. The method of claim 32, wherein the trim panel module further comprises one or more integrated side bolsters injected molded therewith.

49. The method of claim 32, wherein the reinforcement assembly is assembled on the outer panel.

50. The method of claim 32, further comprising assembling a window surround between the outer panel and the trim panel module.

51. The method of claim 50, wherein the reinforcement section is assembled about a lower portion of the window surround.

52. The method of claim 51, wherein the reinforcement section is assembled about a lower portion of the window surround defining a space for a window glass to pass there through.

53. The method of claim 52, wherein the lower portion of the window surround comprises one or more profiles for guiding a window glass thereon.

54. The method of claim 51, wherein the window surround includes a low friction coating at least partially injection molded thereon.
